(19) United States
(12) Patent Application Publication
(10) Pub. No.: US 2002/0056970 A1
(43) Pub. Date: May 16, 2002

(54) Variably adjustable wheelchair apparatus

(76) Inventor: Michael C. Groth, Brookfield, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/013,045

(22) Filed: Nov. 12, 2001

Related U.S. Application Data
(60) Provisional application No. 60/248,111, filed on Nov. 13, 2000.

(51) Int. Cl. B62M 1/14

(52) U.S. Cl. 280/250.1

(57) ABSTRACT

A variably adjustable wheelchair is provided in which the height of the seat of the chair and the angle of the seat relative to the horizontal can be readily and easily changed depending upon the height, depth or angle that is desired or required by the wheelchair user. The wheelchair includes a backrest that is upwardly and downwardly moveable relative to the seat of the chair. The wheelchair also includes a pair of separately and variably adjustable armrests which allow each armrest to be independently raised or lowered. The armrests may also be turned inwardly or outwardly relative to the torso of the user of the wheelchair. The wheelchair also includes a pair of variably adjustable legrests that are completely removable from the wheelchair and rotatable from the front of the wheelchair to the sides of it. The wheelchair also includes a mechanism for adjusting the width of the chair to further facilitate accommodation of it to its users. All fasteners utilized in the wheelchair are driven by a simple, hand-held drive mechanism that is provided with the wheelchair.

### BACKGROUND OF THE INVENTION

The forerunner of the modem wheelchair was a special use item which was really intended to provide limited mobility to a person who was otherwise not ambulatory. Such early wheelchairs would be used, for example, as a device for escorting an expectant mother-to-be from the vehicle that transported her to the hospital to the delivery room. It would also have been used for escorting the proud owner of a freshly-set ankle cast from an emergency room to the vehicle which is intended to take him or her home. Such short term and limited uses were typical of the early wheelchairs.

In the experience of this inventor, such wheelchairs unfortunately continue to be used today as a device for providing long term ambulation to those -who might not otherwise be able to get around on their own. For example, nursing homes and the like often times have residents who spend the better part of their day in a wheelchair of the type described above. Although the wheelchair allows the mobility to wander about the home, it is also a mechanism which is something less than totally comfortable for the resident who is confined to it. The straight back of the typical wheelchair and other predetermined or unvariable dimensions of the wheelchair make it something of a “one size fits all” device. The problem here, however, is that one size does not fit all. There are many different sizes and shapes of wheelchair users, particularly those who must use a wheelchair on a long term or continuous basis, who need variability in such a chair.

### SUMMARY OF THE INVENTION

It is, therefore, a principal object of this invention to provide a new, useful and uncomplicated wheelchair apparatus which is variably adjustable to accommodate a wide variety of sizes and shapes of wheelchair users. It is a further object of this invention to provide such an apparatus which requires a minimal number of elements and which requires only a minimal number of steps to utilize. It is yet another object of this invention to provide such a wheelchair apparatus which is readily and quickly adjustable so as to quickly and easily accommodate the many sizes and shapes of persons who may need to be seated within the wheelchair.

The present invention has obtained these objects. It provides for a wheelchair apparatus in which the height of the seat of the chair, the depth of the chair and the angle of the seat relative to the horizontal can all be readily and easily changed depending upon the height, depth or angle which is desired or required by the wheelchair user. The wheelchair apparatus of the present invention includes a backrest cushion which is upwardly and downwardly moveable relative to the seat of the chair. The wheelchair apparatus of the present invention also includes a pair of separately and variably adjustable wheelchair armrests which allow each armrest to be independently raised or lowered, turned inwardly or outwardly, and moved forwardly and rearwardly relative to the torso of the user of the wheelchair. The wheelchair of the present invention also includes a variably adjustable leg rest which leg rest is also completely removable from the wheelchair apparatus and is rotatable from the front of the chair to the side of the chair. The wheelchair apparatus of the present invention further includes a mechanism for adjusting the width of the chair to further facilitate accommodation of it to its users. All fasteners utilized in the wheelchair apparatus of the present invention are driven by a simple, hand-held drive mechanism which is provided with the apparatus. The foregoing and other features of the wheelchair apparatus of the present invention will be further apparent from the detailed description which follows.

### BRIEF DESCRIPTION OF THE DRAWINGS

FIG. 1 is a front and right side perspective view of a wheelchair apparatus constructed in accordance with the present invention.

FIG. 2 is a left side elevational view of the wheelchair apparatus shown in FIG. 1.

FIG. 3 is an enlarged left side elevational view showing the details of the variability producing mechanisms of the wheelchair apparatus of the present invention.

FIG. 4 is the same left side elevational view shown in FIG. 3, but also showing the angle adjustability of the wheelchair seat.

### DETAILED DESCRIPTION

Referring now to the drawings in detail, FIG. 1 shows a wheelchair apparatus, generally identified 10, constructed in accordance with the present invention. The wheelchair apparatus 10 includes a main frame 1, the major portion of which is constructed of welded tubular steel in the preferred embodiment. The main frame 1 could also be constructed of aluminum or some other sturdy structural material, the material of manufacture not being a limitation of the invention. The main frame 1 includes a pair of symmetrically located central frame members 2. Each central frame member 2 is welded to and extends between a rear seat cushion support 3 and a forward seat cushion support 4. The rear seat cushion support 3 includes a plurality of holes 13 which extend from side to side through each support 3. Similarly, a pair of forward seat cushion supports 4 are provided each of which includes a plurality of holes 14 which extend from side to side through each forward seat cushion support 4. The purpose and function of these holes 13, 14 will become further apparent later in this detailed description. Toward the bottom of the main frame 1 is a pair of symmetrically located bottom frame members 5. Extending generally perpendicularly between each of the bottom frame members 5 of the main frame 1 are two cross bottom frame support members 6. Though not shown, the cross bottom frame support members 6 are variably adjustable such that the distance between the bottom frame members 5 is adjustable to accommodate larger framed wheelchair users.

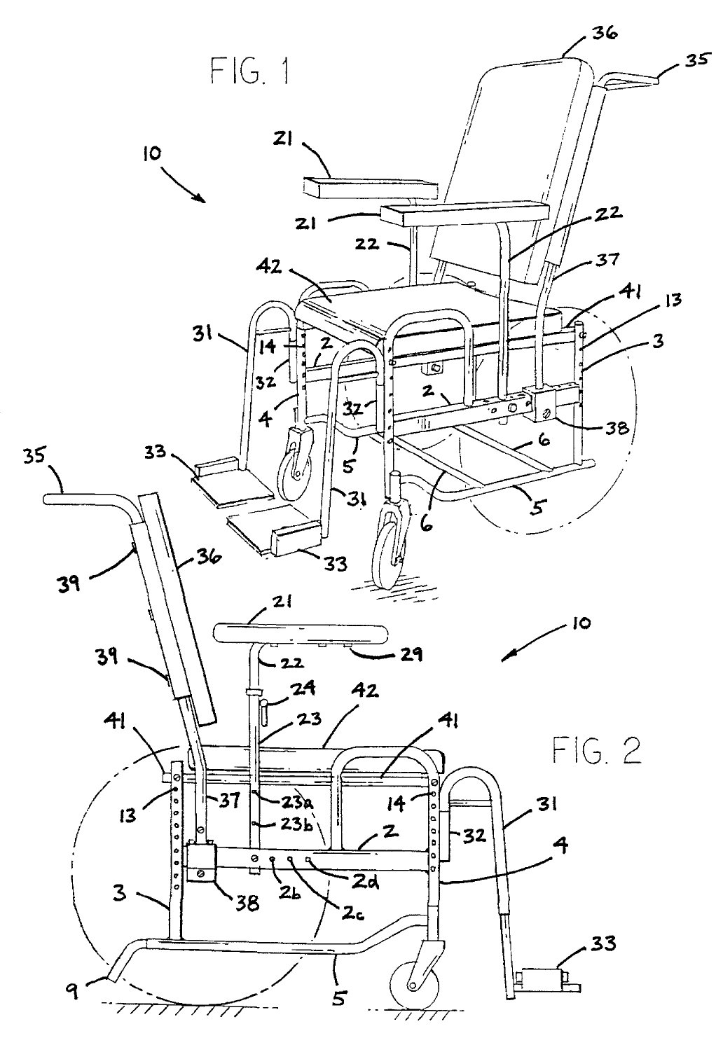

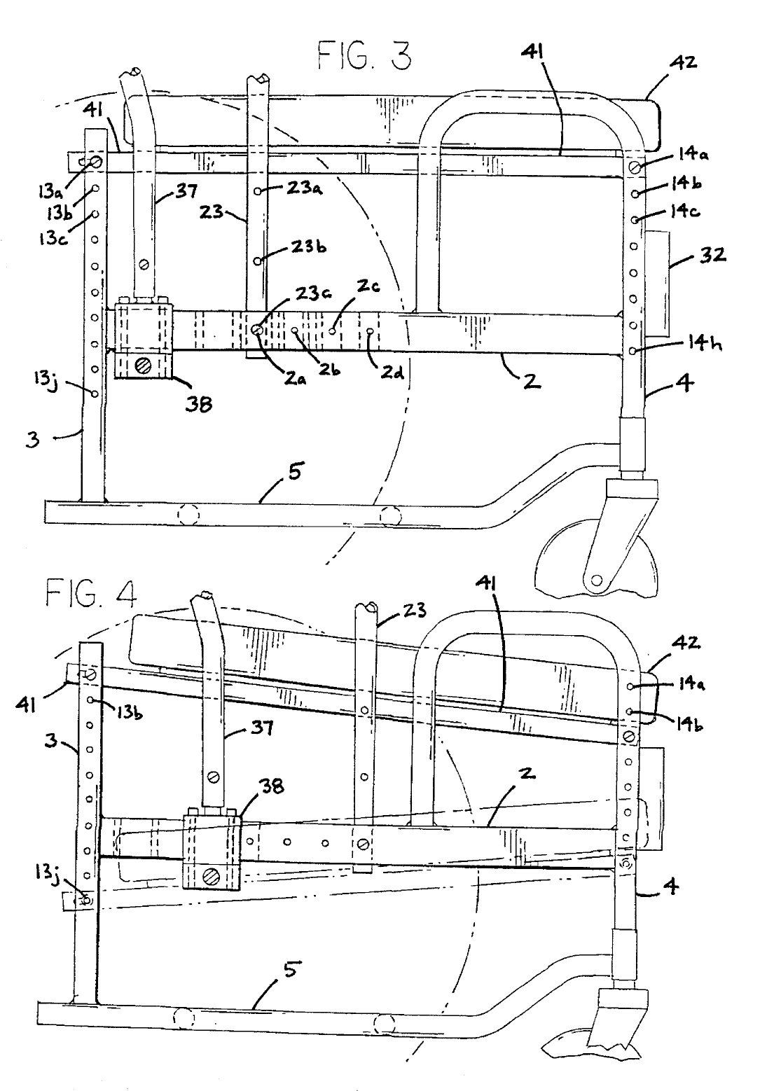

Toward the rear of the main frame 1 is a push handle 35 which is moveably attached to each of the central frame members 2 by means of a pair of backrest frame support brackets 38. Upwardly of each backrest frame support bracket 38 is a backrest frame member 37. Extending between each of the backrest frame members 37 is a removable backrest cushion 36. As shown, each backrest frame support bracket 38 is moveable to the front of the of the main frame 1 of the wheelchair 10 and is fixable in a variety of positions along the central frame member 2. See FIG. 3. The vertical position of the backrest cushion 36 is also movable upwardly and downwardly along the backrest frame member 37 by virtue of repositioning of the cushion fasteners 39 within holes (not shown) defined in the backrest frame member 37. See FIG. 2. Also rearward of the main frame 1 is a pair of anti-tip bars 9 which are intended to provide rearward stability for the main frame 1 in the event the user, for one reason or another, tips the wheelchair 10 backward.

Extending between the rear seat cushion supports 3 and the forward seat cushion supports 4 is a seat cushion frame 41. The seat cushion frame 41 has attached at its uppermost portion a seat cushion 42. As is shown in FIG. 2, the height of the rearward portion of the seat cushion frame 41 is variably adjustable along each of the rear seat cushion supports 3 by means of the holes 13 contained in it. Similarly, the forward portion of the seat cushion frame 41 is vertically adjustable along each of the forward seat cushion supports 4 by means of the holes 14 defined within it. In this configuration, the seat cushion frame 41 is movable upwardly and downwardly along the rear seat cushion supports 3 and the forward seat cushion supports 4 yet remain in a generally horizontal plane. Alternatively, the forward portion of the seat cushion frame 41 may be adjusted along the forward seat cushion supports 4 to a lower position thereby tilting the seat cushion frame 41 downwardly towards the front of the wheelchair 10. Likewise, the rearward portion of the seat cushion frame 41 may be adjusted to a lower position at the rear seat cushion supports 3 such that the seat cushion frame 41 tilts generally downwardly to the rear of the wheelchair 10. In the preferred embodiment, this adjustability is accomplished by use of readily removable allen screws which are accessible via an allen wrench, which wrench is held within a holder which is part of the chair (not shown), and which provide the function of easy removeability and adjustability throughout the assembly 10.

Another feature of the present invention is a pair of complimentary moveable arm rests 21. Each arm rest 21 is separately and vertically moveable relative to the horizontal by means of an armrest support tube 22 which is attached to the underside of the armrest 21. Each armrest support tube 22 is slideable within an armrest support tube sleeve 23 which is attached to each of the central frame members 2 of the main frame 1. The height of the armrest 21 is variably adjustable and fixable by means of a locking clamp 24 which, in the preferred embodiment, is a cam lock 24. The cam lock 24 releasably locks the armrest support tube 22 within the armrest support tube sleeve 23 at whatever height is desired or required. It should also be noted that each armrest support tube sleeve 23 is moveable both forwardly and vertically of the central frame member 2 such that the armrest 21 can be easily and readily repositioned at different points 2a, 2b, 2c, 2d along the central frame member 2 of the main frame 1 as such is desired or required. See FIG. 3. The armrest support tube sleeve 23 is also configured with holes 23a, 23b, 23c for accomplishing this vertical adjustability. The fact that the armrest support tube 22 can move freely within the armrest support tube sleeve 23 also allows the armrest pad 21 to be moved inwardly or outwardly of the seat cushion 42. Furthermore, the armrest pad 21 is, in the preferred embodiment, moveable itself by means of a plurality of attachment fasteners 29 which pass through the uppermost portion of the armrest support tube 22 and are receivable within holes (not shown) defined within the underside of the pad 21. See FIG. 2.

Another feature of the wheelchair apparatus 10 of the present invention is a pair of variably adjustable leg rests 31 which are found at the forward portion of the main frame 1. See FIG. 2. Each leg rest 31 has an upper portion which is slideably receivable within a leg rest support sleeve 32. At the bottom portion of the leg rest 31 is a foot support 33. In the preferred embodiment, each leg rest 31 may be moveable outwardly of the main frame 1 such that it can be swung out of the way when such is desired or required. In the preferred embodiment, the leg rest 31 may even be removed altogether.

As previously alluded to, an important feature of the wheelchair apparatus 10 of the present invention is that all fasteners which are utilized, including those which are used to fix or adjust the position of the seat 42, the backrest 36 and the armrest 21, are functionally adapted to be driven by a single drive tool (not shown) which is provided as an accessory item. The drive tool, in the preferred embodiment, assumes the configuration of a traditional allen wrench with the fastener heads being of the hexagonal drive type. This allows for ease and speed of use when positional changes are desired or required.

In application, the user may locate the wheelchair seat cushion frame 41 at its highest point and in a generally horizontal plane by attaching its rearward portion at the topmost hole 13a of the rear seat cushion support 3 and by attaching its forward portion at the topmost hole 14a of the forward seat cushion support 4. If the user were to create a slight forward incline of the seat cushion frame 41, the next lower hole 13b of the rear seat cushion support 3 could be used. Similarly, a slight rearward incline could be created by using the next lower hole 14b of the forward seat cushion support 4. Greater inclines could be accomplished by using the next lower holes 13c, 14c and so on. In the preferred embodiment, the seat of the present invention is moveable from a low point of 12″ to 19″ from the floor (or 14″ to 21″ using a 2″ seat cushion). The wheelchair apparatus of the present invention can also be angled 1″, 2″ or 3″ toward the front or back at all seat heights (1″ or 2″ at the 12″ is seat height). The depth of the seating area can be similarly adjusted by moving the back rest frame support brackets 38 forward or backward along the central frame members 2 as desired or required. In the preferred embodiment, the seat depth has a range of from 14″ to 21″. The vertical position of the backrest cushion 36 is also movable upwardly and downwardly relative to the seat 42. Finally, longitudinal adjustment of the armrests 21 is accomplished by locating the support tube sleeve 23 in one of four locating holes 2a, 2b, 2c, 2d defined in the central frame member 2 and by repositioning the fasteners 29 along a plurality of holes (not shown) defined in the underside of the armrest 21. The height of the armrests 21 is adjustable by means of holes 23a, 23b, 23c defined within the support tubes 23 and by means of the lock cam 24 which is built into it. In this configuration, the vertical positioning of the armrests 21 is almost limitless. As previously disclosed, each armrest 21 is also rotatable inwardly or outwardly relative to the seat cushion 42.

From the foregoing detailed description of the illustrative embodiment of the invention set forth herein, it will be apparent that there has been provided a new, useful and uncomplicated wheelchair apparatus which is variably adjustable to accommodate a wide variety of sizes and shapes of wheelchair users; which requires a minimal number of elements and which requires only a minimal number of steps to utilize; and which is readily and quickly adjustable so as to quickly and easily accommodate the many sizes and shapes of persons who may need to be seated within the wheelchair.

The principles of this invention having been fully explained in connection with the foregoing, I hereby claim as my invention:

1. A variably adjustable wheelchair comprising
a main wheelchair frame, said main wheelchair frame including a pair of symmetrically located frame members, each frame member being a mirror image of the other, and each frame member including a top portion, a bottom portion, a back portion, a front portion, an inwardly facing portion and an outwardly facing portion,
a pair of large wheels, one being mountable along the outwardly facing portion of each frame member and generally towards the back portion of each frame member,
a pair of small wheels, one being mountable along the bottom portion of each frame member and generally towards the front portion of each frame member,
a seat cushion mountable between said frame members and extending between said inwardly facing frame member portions, and
a backrest mountable to the back portions of the main wheelchair frame members.

2. The wheelchair of claim 1 wherein the seat cushion is attachable to a seat frame, said seat frame having a front portion, a rear portion and a pair of opposing side portions, each of said side portions being adjacent an inwardly facing portion of each frame member and extending therebetween.

3. The wheelchair of claim 2 wherein said front seat frame portion is attachable to the front portion of each frame member and is vertically movable relative thereto whereby the seat is tiltable downwardly to the front of the wheelchair relative to the horizontal.

4. The wheelchair of claim 3 wherein said rear seat frame portion is attachable to the back portion of each frame member and is vertically movable relative thereto whereby the seat is tiltable downwardly to the rear of the wheelchair relative to the horizontal.

5. The wheelchair of claim 4 including a pair of vertically adjustable armrests, one armrest being attachable to each of said wheelchair frame members.

6. The wheelchair of claim 5 wherein said backrest is vertically adjustable relative to the wheelchair seat cushion.

7. The wheelchair of claim 6 including a pair of leg rests, one of each leg rests being removably attachable to the front portion of each wheelchair frame member.

8. The wheelchair of claim 7 including removable attachment means for securing the relative position of said seat frame, said backrest and said armrests by use of uniform bolts throughout.

9. The wheelchair of claim 8 including a drive tool, said drive tool being functionally adapted to drive each of said uniform bolts.

10. The wheelchair of claim 9 wherein said backrest is forwardly and rearwardly adjustable relative to the main wheelchair frame.

11. The wheelchair of claim 10 including a plurality of bottom frame cross members extending generally perpendicularly between the bottom portions of the wheelchair main frame members whereby the distance between the members is adjustable to accommodate larger framed wheelchair users.

12. The wheelchair of claim 2 including an adjustable seat cushion attachment means which comprises a plurality of holes that extend through the seat frame and a plurality of complementary holes that extend through said frame members whereby the seat is tiltably fixable relative to the horizontal.

13. The wheelchair of claim 12 wherein the seat frame is either upwardly or downwardly adjustable by use of a plurality of uniform bolts and by removing the bolts from either the seat frame front portion or the seat frame rear portion, adjusting the level of the seat cushion frame, and replacing the bolts when a the seat cushion is in a suitable position.

14. The wheelchair of claim 13 wherein the bolts that attach the seat cushion frame to the main wheelchair frame are alien screws.

15. The wheelchair of claim 14 wherein a pair vertically mobile armrests are attached to the main wheelchair frame.

16. The wheelchair of claim 15 wherein each armrest is rotatable inwardly and outwardly of the frame member to which it is attached.

17. The wheelchair of claim 16 including a pair of removable and outwardly adjustable leg rests, each leg rest comprising a leg rest support sleeve attached to the front of the each support frame, a leg rest with an upper portion that is slideably receivable within the leg rest support sleeve and a bottom portion, and a foot rest at the bottom portion of the leg rest.

18. The wheelchair of claim 17 wherein said backrest includes a backrest frame comprising a pair of backrest frame support brackets, one each being attached to a main wheelchair frame member and a backrest frame member extending upwardly from each of the backrest frame support brackets wherein the backrest frame support brackets may be loosened and moved horizontally along the main frame members.

19. The wheelchair of claim 18 including a plurality of bottom frame cross members extending generally perpendicularly between the bottom portions of the wheelchair main frame members whereby the distance between the members is adjustable to accommodate larger framed wheelchair users.

20. The wheelchair of claim 19 including removable attachment means for securing the relative position of said seat frame, said backrest and said armrests by use of uniform bolts throughout and further including a drive tool, said drive tool being functionally adapted to drive each of said uniform bolts.
